(19) United States
(12) Patent Application Publication
(10) Pub. No.: US 2011/0023980 A1
(43) Pub. Date: Feb. 3, 2011

(54) PROGRAMMABLE DEVICE FOR COMPRESSOR VALVE

(76) Inventors: Klaus Brun, Helotes, TX (US); Merle E. Converse, Helotes, TX (US); Jerome A. Helffrich, Boerne, TX (US)

Correspondence Address: Nielsen IP Law LLC, 1177 West Loop South, Suite 1600, Houston, TX, 77027, US

(21) Appl. No.: 12/937,836

(22) PCT Filed: Mar. 30, 2009
(86) PCT No.: PCT/US09/38837

§ 371 Date: Oct. 14, 2010

Related U.S. Application Data
(60) Provisional application No. 61/045,193, filed on Apr. 15, 2008.

(51) Int. Cl. F16K 31/02

(52) U.S. Cl. 137/487.5; 251/129.01

(57) ABSTRACT

An electronic, programmable device for controlling the motion of compressor valve elements, wherein the device receives an incoming signal from a velocity sensor located on a compressor valve; filters, amplifies, and processes the incoming signal by a control algorithm; and responds to the incoming signal by creating an output signal that produces an actuator force that is applied directly to a moving valve element and associated methodology.

### CROSS-REFERENCE TO RELATED APPLICATIONS

This application claims priority to U.S. patent application Ser. No. 61/045,193 which is incorporated by reference herein in its entirety.

### STATEMENT REGARDING FEDERALLY SPONSORED RESEARCH OR DEVELOPMENT

None.

### THE NAMES OF THE PARTIES TO A JOINT RESEARCH AGREEMENT

None.

### REFERENCE TO SEQUENCE LISTING

None.

### BACKGROUND OF THE INVENTION

In order to transport gases over great distances, pipeline and oil companies operate and maintain hundreds of thousands of miles of pipelines. Compressed gases are needed to take part in chemical reactions in refineries and petrochemical plants. To provide forces that move and compress the gases, operators install gas compressors at key points in the process chain The gas compressors are typically reciprocating compressors. It costs a lot of money if a gas compressor valve is damaged and/or fails.

### SUMMARY OF THE INVENTION

An electronic, programmable device for controlling the motion of compressor valve elements and associated methods are disclosed herein.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows valve plate motion versus time in controlled and uncontrolled plates.

FIG. 2 depicts uncontrolled plate motion versus controlled plate motion.

FIG. 3 depicts plate velocities in a valve in controlled and uncontrolled plates.

### DETAILED DESCRIPTION

Sealing elements in the inlet and discharge valves of a reciprocating compressor may be moved to the open or closed position by forces imparted by the differential gas pressure to the movable sealing elements. The sealing elements may alternatively open and close with each stroke of the compressor in order to permit gas flow in one direction but block gas flow in the reverse direction. Methods and a device for controlling valve elements though the use of algorithms installed in a programmable control device is provided.

To date, very little has been done to manage the motion of the compressor valve elements. Spring systems, damper plates, and a variety of different geometries can be introduced to slow plate motion or change the timing of certain events, but the forces from the differential gas pressure on each side of the valve often prevent these devices from achieving effective, long term control. Gas forces are the most dominant force affecting valve element motion. Currently valve elements remain predominately uncontrolled and any performance increases are small and incremental at best.

In addition, fixed control devices do not adjust to the dynamic conditions of an operating gas compressor where the environment is dynamic with constant changes in pressure, gas molecular weight, gas velocities, and capacity (mass flow). Typically, these fixed control devices are specifically designed to operate at certain target conditions. When these fixed control devices are used in variable conditions, or conditions outside of their target conditions, these variables alter the motion of the sealing elements in the compressor valve. Whenever any of these variables control valve element motion, the valve may operate in a manner inconsistent with its design, resulting in a reduction of operating life. Specifically, the timing of the commencement or completion of the opening and closing events, duration of the transit between full open and full closed, and the force with which the valve elements strike the rigid structure of the compressor valve during the valves opening and closing may be affected, resulting in more violent valve element motion and unfavorable valve positioning. Violent valve element motion and unfavorable valve positioning can cause the plates in the valves to break or crack and can also result in damage or destruction of the valve springs.

Moreover, compressor valve life is often directly related to the ability of its sealing element to effectuate a tight seal. Failure to seal results in overheating of the valve and often subsequent failure, requiring a shutdown of the compressor for repairs or replacement of parts. Substantial financial costs occur every time process equipment is shut down for repairs. Hence, operators of reciprocating gas compressors want to minimize the number and frequency of these events.

United States publication 2007/0272178A1, at paragraphs [0022]-[0026], incorporated herein by reference, describes the physical requirements of the type of hardware that can be used to control valve element motion. However, the programmable device for making the valve motion fully controllable and adjustable by external means is needed. This electronic, programmable device can sense changing conditions and send new signals to the hardware to restore the desired motion of the valve plates and thus this active control of the valve plate/element motion can keep the valve dynamics within the design envelope of the valve. Therefore, the aforementioned high velocities and severe impacts can be mitigated.

The methods and programmable device provided herein extend compressor valve life by increasing control over valve element motion, the timing of valve element motion, the duration of valve element motion, and the impact forces of valve element motion. This device provides control over the valve element motion, reducing compression losses (i e. inefficiencies). Valve plates that close late for example allow for gas to reverse flow and return to the compressor cylinder. This reverse flow will occur until the valve element closes and blocks the flow. Late closure is defined as the time that the valve plate is open after the compressor piston reached top dead center and has itself reversed direction to start the intake stroke. Having the ability to ensure that the valve elements are closed eliminates that possibility of reverse flow and the compressor performance overall is improved by the removal of this inefficiency. The programmable device and associated methodology further provides mass flow control that can be used to make the compressor provide the exact amount of gas for the operating conditions. Specifically, the programmable logic can be set up to force the valve elements to stay open, thereby permitting reverse flow, for some predetermined period of time. The amount of gas that flows back into the compressor cylinder represents a decrease in the downstream flow of the compressor by an equal amount. Controlling the duration of the time period that the elements are open after the piston reaches top dead center means that this programmable device can be very effective as a capacity controller allowing the compressor operator to simply change the timing of the valve element events.

The programmable device can manage the hardware components with a current wave form so as to produce the desired valve actuator motion profile. The programmable device may further receive an analog or digital signal from a valve element velocity sensor and/or some other dynamic sensor related to the operation of the reciprocating compressor, and then provide either semi or fully controlled valve element motion as desired by the compressor operator or required by the operating conditions. Hence, the device and methods described herein are particularly suitable for controlling electromagnetically actuated valves, such as those described in United States publication 2007/0272178A1. The device controls valve element motion through a semi-active control mode as well as a full control mode.

The control process consists of a multi-step feedback loop that includes the following steps: 1) band pass filtering and pre-amplification of an incoming signal; 2) validation of the signal to determine if the signal is form the valve element motion or simply electrical background noise; 3) calculation of an output signal to determine the appropriate response to the sensed motion, and 4) high gain output signal amplification. Step 3 may include determining the appropriate time delay, output voltage amplitude, signal duration and voltage function shape

While the programmable device can operate in analog or digital modes, step number four (4) is typically an analog function. The shape of the voltage in function step three can be adjusted and optimized to provide the greatest deceleration to the valve element while minimizing the mechanical stresses on the element. Accelerations and other mechanical forces can be analyzed and studied using readily available finite element codes and maximum and minimum thresholds. Furthermore, these forces are sometimes determinative in setting the parameter of the control function in the programmable device. In this way, the programmable device cannot act in manner that would be as destructive to the valve elements when the operating conditions change. The simplest voltage function would have a saw tooth shape but other functions may be programmed depending on the desired plate/element motion. To do this, more sophisticated, higher order, non-linear polynomials could be derived and programmed into the device (controller) logic.

It is this variable functionality that controls the time delays and durations of events that allow external control of the valve efficiency and overall compressor output (capacity). The voltage function is output to the hardware that is physically attached to the valve elements and determines the magnitude, duration and timing of the forces applied to the valve plates. Semi-active and fully active modes operate in the same manner.

The device can receive, calculate and respond at a frequency in the order of 200 KHz. Valve movements occur in the 1000 Hz range and having a device significantly faster than the movements being controlled allows sampling of the input signals to occur before a response is sent out to the hardware devices. Approximately 100 samples are taken of the incoming signals from each opening and closing event. Processing speed and signal sampling are critical to performing step two in the control process.

Valve plate velocities have been slowed to zero just before impact with the valve seat or valves guard (opening and closing) with direct observation with position and velocity sensors in the lab. Typically uncontrolled plate velocities are between 0.5 and 2.5 meters per second and controlled valve plate velocities can be controlled to nearly any value as long as the applied deceleration forces do not result in mechanical stresses that exceed the material of the valve plate.

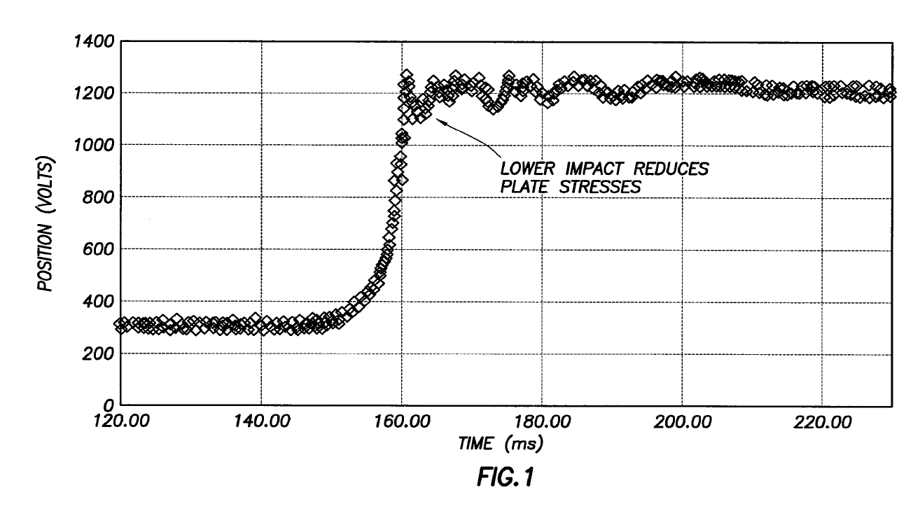

FIG. 1 shows valve plate position vs. time. The blue line is uncontrolled plate motion and it is shown that the plate closes rather abruptly and there are subsequent plate bounces after the initial impact. The red dots show valve plate motion in which the programmable device intervened to slow the valve plate before the initial impact. It is shown that the subsequent bounces have been eliminated thereby subjecting the plate to few violent collisions with other structures in the valve.

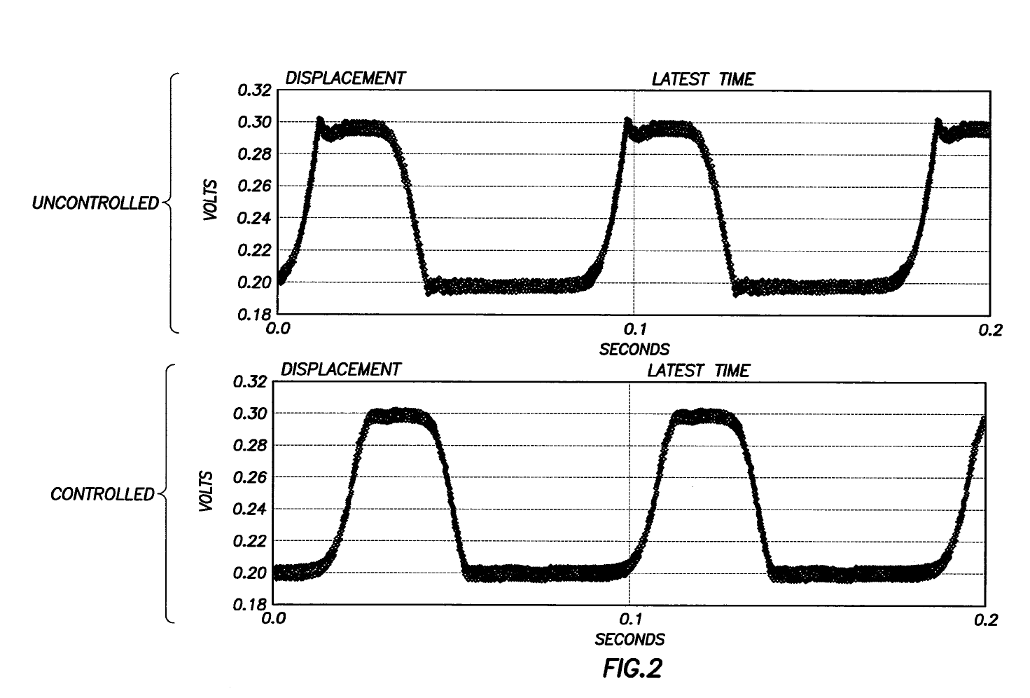

FIG. 2 shows controlled and uncontrolled plate motion. Again, intervention by the programmable device provides obvious smoothing of the valve motion.

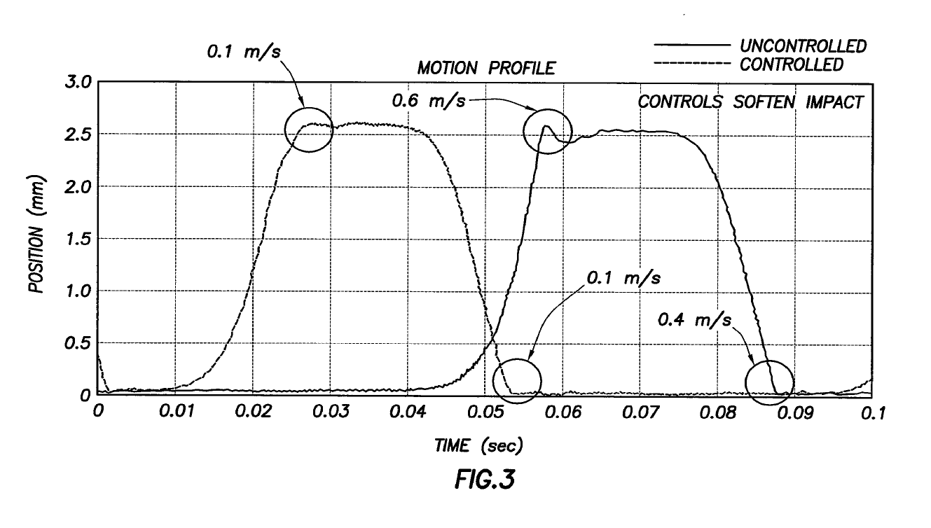

In FIG. 3, the controlled case (the pink curve) shows the plate velocities reduced to 0.1 m/sec compared to the higher velocities of the uncontrolled curve. High velocities mean higher energy at impact and it these forces that cause valve plates to break in service. The programmable device exercising effective control of the valve plate velocities.

The incoming signal is changed to a current vs. time output signal by the control algorithm, producing an appropriate actuator force that may be applied directly to the moving valve element. As a result, the motion profile (displacement vs. time) of the valve element is independent of any pressure or other gas condition. In the semi-active control mode the changing compressor operating conditions change the velocity profile of the valve element and this element velocity is this parameter that is sensed and acted upon by the programmable device. This operation mode acts on measured valve element velocities and the control algorithm adjusts to changing velocities making this system self-adjustable to varying compressor operating conditions.

Valve element motion may be also controlled through a full control mode. In this mode, additional inputs from devices such as a key phasor reading the compressor crankshaft or flywheel and a motor or an engine drive shaft encoder are available as well as other signals that are synchronized with the operation of the reciprocating gas compressor. Incoming signals may be filtered, amplified, processed as previously described and combined with the other signals for manipulation by the control algorithm. The incoming signal generates a current vs. time output signal that may produce an appropriate actuator force to be applied to the moving valve element. The application of this force may change the motion profile of the valve element independent of any pressure of gas condition. This operation mode acts on measured valve elements and shaft signals as the control algorithm adjusts to the changing signals making this system self-adjustable to varying compressor operating conditions. This operating mode is suitable for compressor capacity (mass flow) control.

Hence, the programmable device can achieve performance objectives by monitoring the valve element. The semi-active and full control modes allow for the establishment of target thresholds through the control of the valve element displacement profile, the valve element velocity profile, the valve element impact velocity profile, and the magnitude of forces sent to the valve element.

The semi-active and full control modes provides for the establishment of target thresholds. Target thresholds, such as minimum and maximum velocities of valve element motion and duration of valve element motion, can be programmed to reduce dynamic impact forces, control the timing of the valve element opening and closing events, change mass flow through the compressor, control the magnitude of the corrective forces sent to the valve elements, and to control valve plate velocities during operation.

Specifically, the semi-active and full control modes further allows for the control of the valve element displacement, element velocity and element impact velocity profiles. The programmable device can provide control of the valve element displacement profile (element position vs. time), element velocity profile and element impact velocity profile.

The semi-active and full control modes may also allow for the control of the magnitude of forces sent to the valve element. The programmable device can provide control of the magnitude of the forces sent to the valve element by limiting the output force of the hardware to some maximum value during operation.

The methods and device described herein provide for external control of the motion of the compressor valve elements and offer the opportunity to improve compressor valve life by reducing the magnitude of the destructive forces generated during the opening and closing events and the timing and duration of the valve motion.

What is claimed is:

1. An electronic, programmable device for controlling the motion of compressor valve elements, wherein the device:
receives an incoming signal from a velocity sensor located on a compressor valve;
filters, amplifies, and processes the incoming signal by a control algorithm; and
responds to the incoming signal by creating an output signal that produces an actuator force that is applied directly to a moving valve element.

2. The device of claim 1, wherein the device:
receives an incoming signal from a velocity sensor located on a compressor valve and an additional incoming signal from at least one sensor selected from the group consisting of: a key phasor, a motor or engine drive shaft encoder, and some other sensor that is synchronized with operating a reciprocating compressor;
filters, amplifies, and processes the incoming signals by a control algorithm; and
responds to the incoming signals by creating an output signal that produces an actuator force that is applied directly to a moving valve element.

3. An electromagnetically actuated valve that is controlled by an electronic, programmable device, wherein the device:
receives an incoming signal from a velocity sensor located on the electromagnetically actuated valve;
filters, amplifies, and processes the incoming by a control algorithm; and
responds to the incoming signal by creating an output signal that produces an actuator force that is applied directly to a moving valve element of the electromagnetically actuated valve.

4. The electromagnetically actuated valve of claim 3, wherein the device:
receives an incoming signal from a velocity sensor located on the electromagnetically actuated valve and an additional incoming signal from at least one sensor selected from the group consisting of: a key phasor, a motor or engine drive shaft encoder, and some other sensor that is synchronized with operating a reciprocating compressor;
filters, amplifies, and processes the incoming signals by a control algorithm; and
responds to the incoming signals by creating an output signal that produces an actuator force that is applied directly to a moving valve element of the electromagnetically actuated valve.

5. An improved valve comprising a valve housing having at least one input port and at least one output port; a plate within the housing the moves up and down within the housing to control passage of fluid through the valve; at least one shaft attached to one side of the plate at least one magnet attached to the shaft; at least one coil surrounding the shaft that is operable to sense motion of the plate and to control the motion of the plate, wherein the improvement comprising:
an electronic, programmable device for receiving a signal from at least one coil, for interpreting the signal as motion of the plate, and for delivering a signal to at least one coil to control motion of the plate wherein the programmable device filters, amplifies, and processes the signal by a control algorithm wherein said programmable device:
receives an incoming signal from a velocity sensor located on the electromagnetically actuated valve;
filters, amplifies, and processes the incoming signal by a control algorithm; and
responds to the incoming signal by creating an output signal that produces an actuator force that is applied directly to a moving valve element of the electromagnetically actuated valve.
